(19) United States
(12) Patent Application Publication
(10) Pub. No.: US 2010/0277610 A1
(43) Pub. Date: Nov. 4, 2010

(54) Apparatus, Method And Computer Program Product Providing a Light Source With Memory

(75) Inventors: Hannu Kakkori, Tokyo (JP); Mikko Perala, Kangasala (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/516,273

(22) PCT Filed: Nov. 29, 2006
(86) PCT No.: PCT/IB06/03403

§ 371 Date: Jun. 24, 2010

(51) Int. Cl. H04N 9/68; H04N 9/73; H04N 5/222

(52) U.S. Cl. 348/223.1; 348/234; 348/370; 348/E09.051; 348/E09.053; 348/E05.022

(57) ABSTRACT

An apparatus, method and computer program product are provided for a light source having a memory. The method includes: capturing image data in conjunction with use of a light source; obtaining a light source-related parameter from the light source; and performing image processing on the captured image data in order to form an image, wherein the image processing utilizes the light source-related parameter.

### TECHNICAL FIELD

The teachings in accordance with the exemplary embodiments of this invention relate generally to photography and, more specifically, relate to a light source used in conjunction with photography.

### BACKGROUND

Generally, photography is the recording of light (i.e. electromagnetic radiation). That is, photography produces records (e.g., paper photographs, videos, digital files) of images corresponding to what can be seen as by incident, reflected or emissive light, for example. Due to this aspect of photography, light can play an important role in producing a desired record. For example, if the ambient light conditions are such that the subject is too dark to produce a desired record (e.g., the subject is in a dark room), the subject may be illuminated by using a light source (e.g., a flash). Most conventional still cameras and some video cameras have a built-in flash to assist the user.

In addition to the relative brightness of the lighting conditions, there are other aspects that can affect the record produced by photography. For example, if the light is produced by incandescent or fluorescent light bulbs, the color in the photographs may be affected by the source of light. As an example, if an incandescent light bulb is the light source for the subject, the light is generally more red than average daylight.

To combat such effects, the record may be adjusted. As non-limiting examples, the photograph may be filtered (e.g., with a blue filter) prior to final production or image processing may be performed on the digital image. In the latter example, the image processing may be automatic (e.g., performed by the camera) or manual (e.g., performed by the user using software on a computing device).

### SUMMARY

In an exemplary aspect of the invention, a method is provided. The method includes: capturing image data in conjunction with use of a light source; obtaining a light source-related parameter from the light source; and performing image processing on the captured image data in order to form an image, wherein the image processing utilizes the light source-related parameter.

In another exemplary aspect of the invention, a computer program product is provided. The computer program product includes program instructions embodied on a tangible computer-readable medium. Execution of the program instructions results in operations including: obtaining a light source-related parameter from a light source; and, in response to capturing image data in conjunction with use of the light source, performing image processing on the captured image data in order to form an image, wherein the image processing utilizes the light source-related parameter.

In a further exemplary aspect of the invention, an electronic device is provided. The electronic device includes: a light source module having a memory and a light source, wherein the memory has a light source parameter of the light source; a camera module configured to capture image data in conjunction with use of the light source; and an image processing module for processing the image data in order to form an image, wherein the image processing module is coupled to the light source module and to the camera module, wherein the image processing module is configured to obtain the light source parameter from the light source module and to use the light source parameter when performing image processing on the captured image data.

In another exemplary aspect of the invention, a light source module is provided. The light source module includes: a light source; a communication interface; and a memory coupled to the communication interface, wherein the memory is configured to store a light source parameter of the light source.

In a further exemplary aspect of the invention, a light source module interface is provided. The light source module interface includes a pathway configured to enable communication between a light source module and an image processing module. The pathway is further configured to enable the light source module to transmit a light source parameter stored in the light source module from the light source module to the image processing module.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 illustrates an example of conventional architecture for an image-capturing electronic device;

FIG. 2 shows an example architecture for an image-capturing electronic device incorporating aspects of the exemplary embodiments of the invention;

FIG. 3 illustrates a simplified block diagram of another electronic device that is suitable for use in practicing the exemplary embodiments of the invention; and

FIG. 4 depicts a flowchart illustrating one non-limiting example of a method for practicing the exemplary embodiments of this invention.

### DETAILED DESCRIPTION

Before a photograph can be shown on the display of a camera phone, for example, the captured image data must first be processed. This processing sequence, also referred to herein as the imaging chain, includes functions to: construct the image from the sensor's data, adjust the color of the image, attenuate noise and geometrical distortion, and adjust sharpness of the image, as non-limiting examples. With regard to a general description of the imaging chain, reference may be made to an online publication “Camera imaging chain,” Nokia, 2006.

The imaging chain controls the sensor and image capturing process. The chain may include enhancement and restoration functions such as: Color Filter Array interpolation, white balance adjustment, gamma correction, color gamut conversion, geometrical distortion correction, shading (vignetting) elimination, noise reduction, and sharpening, as non-limiting examples. For additional descriptions of the above-recited functions, reference may made to an online publication “Camera Imaging Chain Demo,” Nokia, 2004.

Various aspects of the light source may be different depending on the type of light source used (e.g., light emitting diode (LED), Xenon tube) and specific production qualities (e.g., tolerance of light source components), for example. As the light source can affect the record produced by photography, it is beneficial to consider parameters of the light source when producing the final record. In such a manner, effects of the light source (e.g., color shifts) can be considered. As non-limiting examples, the light source parameters may include: light intensity, color temperature, spectrum, timing and maximum light output.

As noted above, the user equipment (i.e. the electronic device) may compensate for light source effects by performing image processing based on one or more light source parameters, as a non-limiting example. Furthermore, the architecture of the electronic device may be based on a modular system of components. As utilized herein, a modular system or modular device is considered to be a system or device, respectively, that comprises a plurality of modules with each module fulfilling at least one unique function.

As an example of a modular device, consider an electronic camera having a built-in flash. The camera comprises a plurality of components that were assembled to produce the final product. The built-in flash, although coupled to the primary data processor and likely controlled by it, was probably constructed independently of the main body of the camera and subsequently attached or installed with the appropriate connections (e.g., to the data processor or other controller that directs the operation of the flash). For example, it is possible that the light source module of this camera could be replaced by another light source module having the appropriate size, shape and connections without substantially affecting the operation or use of the camera (e.g., the camera could be enabled to operate with any one of a plurality of potential light source modules). In such a manner, even though the camera itself may comprise a singular electronic device, the camera comprises a plurality of modules that may each be distinguished from one another.

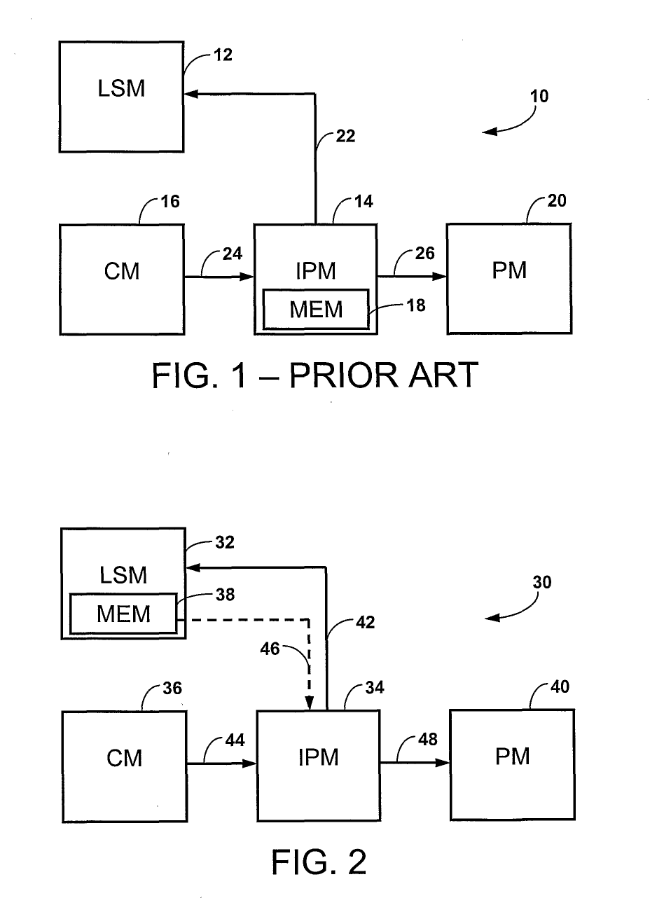

FIG. 1 illustrates an example of conventional architecture for an image-capturing electronic device 10. As non-limiting examples, the electronic device 10 may comprise a digital camera or a digital video recorder. The electronic device 10 includes a light source module (LSM) 12 coupled to an image processing module (IPM) 14 and a camera module (CM) 16 coupled to the IPM 14. The LSM 12 includes a source of illumination such as a light-emitting diode (LED), for example. The CM 16 is configured to capture an image in conjunction with use of the LSM 12. That is, the LSM 12 is employed to provide light when capturing an image with the CM 16. The IPM 14 is configured to receive the captured image from the CM 16. In the conventional electronic device 10 of FIG. 1, the IPM 14 comprises a memory (MEM) 18 which stores at least one light source parameter. The IPM 14 uses the at least one light source parameter when performing image processing on the captured image received from the CM 16. The electronic device 10 may further comprise a phone module (PM) 20 coupled to the IPM 14. The PM 20 may be used to communicate with other electronic devices, such as through a cellular communication system, for example. The PM 20 may also control the operation of a display screen on the electronic device 10.

In practice, a picture is taken using the CM 16 and the LSM 12. The LSM 12 is operated using a control signal sent to the LSM 12 from the IPM 14 through a connection 22. Image data is received by the IPM 14 from the CM 16 through a connection 24. The IPM 14 performs various image processing on the image data, including processing to account for at least one light source parameter stored in the MEM 18. The final image is then sent from the IPM 14 to the PM 20 through a connection 26 for display and/or storage.

The at least one light source parameter is usually obtained through a calibration process. The measurement for the calibration process may be performed by the electronic device 10 (e.g., by the CM 16) or by an external device that communicates the measurement to the electronic device 10. In either case, the calibration would be based on the final product, that is, on the final, produced device. Furthermore, since the calibration would necessarily be based on the final product, the calibration would have to be performed by the producer and/or manufacturer of the device. If different components (e.g., different light source modules) are used in different production runs, this may affect the calibrated light source parameters.

In other conventional embodiments, the light source parameters simply may not be compensated for with image processing. As a non-limiting example, potential variations in light source components may be minimized in production of the light source by strict control and/or better, more expensive components. Light source modules produced in such a manner would likely be more expensive, possibly leading to an increased cost in the final product (e.g., a higher-priced camera).

Thus, it would be advantageous to provide the light source parameters in a manner by which additional processing (e.g., calibration of the final product) is not needed. The exemplary embodiments of the invention afford such an advantage by providing a light source (i.e. a light source module) having a memory. The memory may comprise at least one light source parameter put there during the manufacturing and/or production of the light source module. In such a manner, the light source parameter(s) particular to that specific light source are provided with the light source for use by the device. The device can read the light source parameter(s) from the memory in the light source module and utilize the parameter(s) in image processing performed on images taken in conjunction with use of that light source. In such a manner, additional calibration of the device to account for the light source parameter(s) is unnecessary. This would be useful in implementing mass-production camera systems, potentially leading to a shorter manufacturing time and/or a lower system cost. In addition, higher parameter variations could be tolerated, potentially leading to lower constituent part cost. One potential downside might be the additional material cost of the added memory in the light source module. However, this additional cost could be compensated for in the module cost and likely does not outweigh the other advantages provided by the exemplary embodiments of the invention.

FIG. 2 shows an example architecture for an image-capturing electronic device 30 incorporating aspects of the exemplary embodiments of the invention. As non-limiting examples, the electronic device 30 may comprise a digital camera, a digital video recorder or a mobile electronic device having a camera system (e.g., a cellular telephone having a camera). Although shown in FIG. 2 in conjunction with a phone module, the exemplary embodiments of the invention are not limited to devices having such or similar communication capabilities. As a non-limiting example, the exemplary embodiments of the invention may be utilized in a digital camera having a flash.

The electronic device 30 of FIG. 2 includes a light source module (LSM) 32 coupled to an image processing module (IPM) 34 and a camera module (CM) 36 coupled to the IPM 34. The LSM 32 includes a source of illumination such as a light-emitting diode (LED), for example. The CM 36 is configured to capture an image (i.e. produce image data) in conjunction with use of the LSM 32. That is, the LSM 32 is employed to provide light when capturing an image with the CM 36. The IPM 34 is configured to receive the captured image (i.e. image data) from the CM 36. In the electronic device 30 of FIG. 2, the LSM 34 further comprises a memory (MEM) 38 which stores at least one light source parameter. The IPM 34 receives the at least one light source parameter and uses the at least one light source parameter when performing image processing on the captured image received from the CM 36. The electronic device 30 may further comprise a phone module (PM) 40 coupled to the IPM 34. The PM 40 may be used to communicate with other electronic devices, such as through a cellular communication system, for example. The PM 40 may also control the operation of a display screen on the electronic device 30.

In practice, a picture is taken using the CM 36 and the LSM 32. The LSM 32 is operated using a control signal sent to the LSM 32 from the IPM 34 through a connection 42. Image data is received by the IPM 34 from the CM 36 through a connection 44. At least one light source parameter stored in the MEM 38 is received by the IPM 34 through a connection 46. The IPM 34 performs various image processing on the image data, including processing to account for the at least one light source parameter. The final image is then sent from the IPM 34 to the PM 40 through a connection 48 for display, storage and/or other actions (e.g., deletion).

In the exemplary embodiment shown in FIG. 2, the at least one light source parameter stored in the MEM 38 was included with the LSM 32. That is, the light source of the LSM 32 and/or the entirety of the LSM 32 was calibrated at the production site by the manufacturer to determine the at least one light source parameter. The determined at least one light source parameter was then stored in the MEM 38 and, thus, provided with the LSM 32.

Although shown in FIG. 2 with two different connections 42, 46 between the LSM 32 and the IPM 34, in other embodiments there may be only one, bidirectional connection between the two components. That is, in other embodiments, connection 42 and connection 46 may comprise a single, bidirectional connection. In further embodiments, the IPM 34 and the PM 40 may comprise a single module. That is, the PM 40 may comprise the IPM 34. In other embodiments, the electronic device 30 may comprise one or more processors (e.g., data processors, microprocessors) that perform the functions of the IPM 34 and the PM 40.

In further embodiments, the electronic device 30 may comprise a greater number of modules. In other embodiments, the electronic device 30 may comprise a lesser number of modules. In further embodiments, the MEM 38 may be integrated with one or more other components in the LSM 32. In other embodiments, the interface for the connection 46 may comprise an I²C interface or bus. In this regards, reference may be made to “The I²C Bus Specification,” Philips Semiconductors, version 2.1, January 2000.

As a non-limiting example, the LSM 32 may comprise a Xenon tube module with a memory. Generally, the maximum light output of a Xenon light source may vary due to one or more tolerances of the components. The memory of the Xenon tube module may contain at least one light source parameter indicative of the tolerance(s) of the components and/or expressive of the effects of such tolerance(s). As a non-limiting example, the Xenon tube module may contain an I²C interface for communication with the IPM 34. As an additional non-limiting example, the memory could be integrated with other components in the LSM 32, such as a driver integrated circuit, for example.

As an additional non-limiting example, the LSM 32 may comprise a LED light source module (LSM) with a memory. Generally, a typical problem with LED light sources is the variation in light color temperature. More specifically, the light output spectrum may vary. The memory of the LED LSM may contain at least one light source parameter indicative of color temperature information. As a non-limiting example, the LED LSM may contain an I²C interface for communication with the IPM 34. In other embodiments, if the pin count of the module were an issue, lower pin count components may be utilized.

In other embodiments, the IPM 34 obtains the at least one light source parameter by reading the at least one light source parameter from the MEM 38. In further embodiments, the captured at least one image comprises information (image data and or color information, as non-limiting examples) corresponding to the captured at least one image. In other embodiments, the use of the light source comprises sending a control signal to the light source, wherein the control signal controls activation of the light source. In further embodiments, the CM 36 comprises the IPM 34. In other embodiments, the exemplary architecture shown in FIG. 2 is utilized in an electronic device, where the electronic device comprises one of: a digital camera, a digital video recorder, or a communication device having a camera function. In general, the various embodiments of the electronic device can include, but are not limited to, cellular telephones, personal digital assistants (PDAs) having photography capabilities, portable computers having photography capabilities, image capture devices such as digital cameras or digital video recorders, gaming devices having photography capabilities, music storage and playback appliances having photography capabilities, Internet appliances having photography capabilities, as well as portable units or terminals that incorporate combinations of such functions.

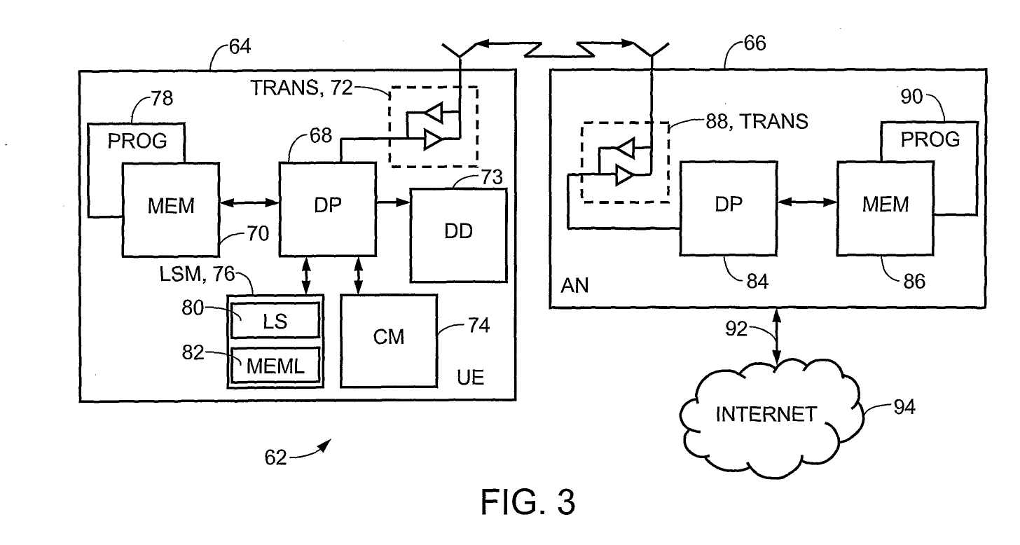

Reference is made to FIG. 3 for illustrating a simplified block diagram of various electronic devices that are suitable for use in practicing the exemplary embodiments of this invention. In FIG. 3, a wireless network 62 is adapted for communication with a user equipment (UE) 64 via an access node (AN) 66. The UE 64 includes a data processor (DP) 68, a memory (MEM) 70 coupled to the DP 68, a suitable RF transceiver (TRANS) 72 (having a transmitter (TX) and a receiver (RX)) coupled to the DP 68, a display device (DD) 73 coupled to the DP 68, a camera module (CM) 74 coupled to the DP 68 and a light source module (LSM) 76 coupled to the DP 68. The MEM 70 stores a program (FROG) 78. The TRANS 72 is for bidirectional wireless communications with the AN 16. Note that the TRANS 72 has at least one antenna to facilitate communication. The LSM 76 has a light source (LS) 80 and a memory (MEML) 82. The MEML 80 stores at least one light source parameter corresponding to at least one aspect, quality or characteristic of the LS 80. The UE 64 may further comprise additional components such as additional memory, addition data processors and one or more input devices, as non-limiting examples.

The AN 66 includes a data processor (DP) 84, a memory (MEM) 86 coupled to the DP 84, and a suitable RF transceiver (TRANS) 88 (having a transmitter (TX) and a receiver (RX)) for bidirectional wireless communications with the UE 64. The MEM 86 stores a program (PROG) 90. Note that the TRANS 88 has at least one antenna to facilitate communication. The AN 66 is coupled via a data path 92 to one or more external networks or systems, such as the internet 94, for example.

In accordance with the exemplary embodiments of the invention as further described herein, the CM 74 captures an image by obtaining image data in conjunction with the use of the LSM 76. The image data is sent from the CM 74 to the DP 68. In addition, at least one light source parameter is sent from the MEML 82 of the LSM 76 to the DP 68 for use in image processing. The DP 68, in conjunction with the PROG 78 stored in the MEM 70, performs image processing on the received image data to produce a final image. At least part of the image processing is based on the received at least one light source parameter. The final image may be displayed on the DD 73 for a user to see. The final image may be stored in the MEM 70 or it may be stored in another memory (not shown) in or coupled to the UE 64. A user may store, delete or further manipulate the final image, as non-limiting examples, by using an input device (not shown) coupled to the DP 68.

Some exemplary embodiments of the invention may comprise the LSM 76, the UE 64 and/or other combinations of components where such combinations include the LSM 76 or a structure acting in a manner similar to that of the LSM 76 as described herein and with further reference to FIGS. 1-2 and 4. In other embodiments, at least one of the PROGs 78, 90 is assumed to include program instructions that, when executed by the associated DP, enable the electronic device to operate in accordance with the exemplary embodiments of this invention, as discussed herein. The exemplary embodiments of this invention may be implemented by computer software executable by one or more of the DPs 68, 84 of the UE 64 and the AN 66, or by hardware, or by a combination of software and hardware.

In general, the various embodiments of the UE 64 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 70, 82, 86 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 68, 84 may be of any type suitable to the local technical environment, and may include one or more of general purpose computers, special purpose computers, microprocessors, digital signal processors (DSPs) and processors based on a multi-core processor architecture, as non-limiting examples.

The CM 74 may be of any type suitable to the local technical environment, and may include one or more of imaging sensors, color filter arrays and optics, as non-limiting examples. The LSM 76 may be of any type suitable to the local technical environment. The LS 80 may be any suitable source of illumination such as one or more incandescent bulbs, fluorescent bulbs, LEDs and Xenon tubes, as non-limiting examples.

Exemplary embodiments of the invention may further comprise a light source module. The light source module comprises: at least one light source; a communication interface; and a memory coupled to the communication interface, wherein the memory is configured to store at least one light source parameter of the at least one light source.

In other embodiments of such a light source module, the at least one light source parameter comprises at least one of light intensity, color temperature, spectrum, timing and maximum light output. In further embodiments, the communication interface comprises an I²C interface. In other embodiments, the at least one light source comprises at least one light emitting diode. In further embodiments, the at least one light source comprises at least one Xenon tube.

Exemplary embodiments of the invention may further comprise a light source module interface. The light source module interface comprises at least one pathway configured to enable communication between a light source module and an image processing module, wherein the at least one pathway is further configured to enable the light source module to transmit at least one light source parameter stored in the light source module from the light source module to the image processing module.

In other embodiments of such a light source module interface, the at least one light source parameter comprises at least one of: light intensity, color temperature, spectrum, timing and maximum light output. In further embodiments, wherein the light source module interface comprises an I²C interface.

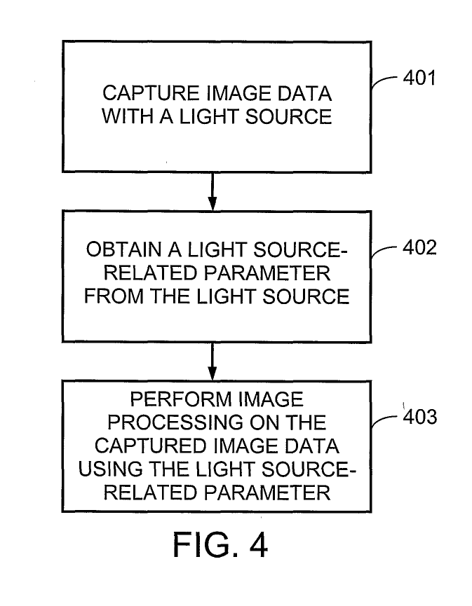

FIG. 4 depicts a flowchart illustrating one non-limiting example of a method for practicing the exemplary embodiments of this invention. In box 401, image data is captured in conjunction with the use of a light source. The image data may be captured in conjunction with the use of one or more sensors. In box 402, a light source-related parameter is obtained from the light source. In box 403, image processing is performed on the captured image data in order to form an image. The image processing utilizes the light source-related parameter.

In other embodiments, the at least one light source-related parameter comprises at least one of: light intensity, color temperature, spectrum, timing and maximum light output. In further embodiments, the image processing comprises at least one of: Color Filter Array interpolation, white balance adjustment, gamma correction, color gamut conversion, geometrical distortion correction, shading (vignetting) elimination, noise reduction, and sharpening.

In other embodiments, the use of the light source comprises sending a control signal to the light source, wherein the control signal controls activation of the light source. In further embodiments, the at least one light source-related parameter comprises data stored in a memory. In other embodiments, obtaining the at least one light source-related parameter comprises reading the data from the memory. In further embodiments, the captured at least one image comprises information (image data and or color information, as non-limiting examples) corresponding to the captured at least one image.

The exemplary method shown in FIG. 4, in addition to other exemplary embodiments of the invention as further described herein, may be implemented as a computer program product comprising program instructions embodied on a tangible computer-readable medium, execution of the program instructions resulting in operations comprising the exemplary method of FIG. 4.

While the exemplary embodiments have been described above in the context of a cellular communication system, it should be appreciated that the exemplary embodiments of this invention are not limited for use with only this one particular type of wireless communication system, and that they may be used to advantage in other wireless communication systems.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

1. A method comprising:
capturing image data in conjunction with use of a light source;
obtaining a light source-related parameter from the light source; and
performing image processing on the captured image data in order to form an image, wherein the image processing utilizes the light source-related parameter.

2. The method of claim 1, wherein the light source-related parameter comprises data stored in a memory.

3. The method of claim 1, wherein the light source-related parameter comprises data stored in a memory and wherein the light source comprises the memory.

4. The method of claim 2, wherein obtaining the light source-related parameter comprises reading the data from the memory.

5. The method of claim 1, wherein the light source-related parameter comprises at least one of: light intensity, color temperature, spectrum, timing and maximum light output.

6. The method of claim 1, wherein the image processing comprises at least one of: Color Filter Array interpolation, white balance adjustment, gamma correction, color gamut conversion, geometrical distortion correction, shading (vignetting) elimination, noise reduction, and sharpening.

7. The method of claim 1, wherein the use of the light source comprises sending a control signal to the light source, wherein the control signal controls activation of the light source.

8. A computer-readable medium tangibly embodying program instructions, execution of the program instructions resulting in operations comprising:
obtaining a light source-related parameter from a light source; and
in response to capturing image data in conjunction with use of the light source, performing image processing on the captured image data in order to form an image, wherein the image processing utilizes the light source-related parameter.

9. The computer-readable medium of claim 8, wherein the light source-related parameter comprises data stored in a memory.

10. The computer-readable medium of claim 8, wherein the light source-related parameter comprises data stored in a memory and wherein the light source comprises the memory.

11. The computer-readable medium of claim 9, wherein obtaining the light source-related parameter comprises reading the data from the memory.

12. The computer-readable medium of claim 8, wherein the light source-related parameter comprises at least one of: light intensity, color temperature, spectrum, timing and maximum light output.

13. The computer-readable medium of claim 8, wherein the image processing comprises at least one of: Color Filter Array interpolation, white balance adjustment, gamma correction, color gamut conversion, geometrical distortion correction, shading (vignetting) elimination, noise reduction, and sharpening.

14. The computer-readable medium of claim 8, wherein the use of the light source comprises sending a control signal to the light source, wherein the control signal controls activation of the light source.

15. An electronic device comprising:
a light source module comprising a memory and a light source, wherein the memory comprises a light source parameter of the light source;
a camera module configured to capture image data in conjunction with use of the light source; and
an image processing module for processing the image data in order to form an image, wherein the image processing module is coupled to the light source module and to the camera module, wherein the image processing module is configured to obtain the light source parameter from the light source module and to use the light source parameter when performing image processing on the captured image data.

16. The electronic device of claim 15, wherein the image processing module obtaining the light source parameter comprises the image processing module reading the light source parameter from the memory.

17. The electronic device of claim 15, wherein the light source parameter comprises at least one of: light intensity, color temperature, spectrum, timing and maximum light output.

18. The electronic device of claim 15, wherein the image processing comprises at least one of: Color Filter Array interpolation, white balance adjustment, gamma correction, color gamut conversion, geometrical distortion correction, shading (vignetting) elimination, noise reduction, and sharpening.

19. The electronic device of claim 15, wherein the camera module comprises the image processing module.

20. The electronic device of claim 15, wherein the light source comprises at least one of the following: a light emitting diode and a Xenon tube.

21. The electronic device of claim 15, wherein the electronic device further comprises an interface between the light source module and the image processing module.

22. The electronic device of claim 21, wherein the interface comprises an I²C interface.

23. The electronic device of claim 15, wherein the electronic device comprises one of: a digital camera, a digital video recorder, or a communication device having a camera function.

24. A light source module comprising:
a light source;
a communication interface; and
a memory coupled to the communication interface, wherein the memory is configured to store a light source parameter of the light source.

25. The light source module of claim 24, wherein the light source comprises the memory.

26. The light source module of claim 24, wherein the light source parameter comprises at least one of: light intensity, color temperature, spectrum, timing and maximum light output.

27. The light source module of claim 24, wherein the communication interface comprises an I²C interface.

28. The light source module of claim 24, wherein the light source comprises at least one of: a light emitting diode and a Xenon tube.

29. A light source module interface comprising a pathway configured to enable communication between a light source module and an image processing module, wherein the pathway is further configured to enable the light source module to transmit a light source parameter stored in the light source module from the light source module to the image processing module.

30. The light source module interface of claim 29, wherein the light source parameter comprises at least one of: light intensity, color temperature, spectrum, timing and maximum light output.

31. The light source module interface of claim 29, wherein the light source module interface comprises an I²C interface.
